(19) United States
(12) Patent Application Publication
(10) Pub. No.: US 2024/0403036 A1
(43) Pub. Date: Dec. 5, 2024

(54) APPLICATION PROGRAM MANAGEMENT SYSTEM AND APPLICATION PROGRAM MANAGEMENT METHOD

(71) Applicants: Digiwin Software Co., Ltd, Shanghai (CN); DATA SYSTEMS CONSULTING CO., LTD., New Taipei City (TW)

(72) Inventors: Li Zhuang, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/351,506

(22) Filed: Jul. 13, 2023

(30) Foreign Application Priority Data
May 29, 2023 (CN) 202310615518.5

(51) Int. Cl. G06F 8/71; G06F 8/65

(52) U.S. Cl. CPC G06F 8/71; G06F 8/65

(57) ABSTRACT

The disclosure provides an application program management system and an application program management method. A development server, a version manager, and a development database are included. The development server includes and executes a version management module. The version management module establishes a corresponding branch according to the branch establishing command and inputs version application information in the branch establishing command to the version manager. The version manager searches and obtains a corresponding configuration code according to the version application information and inputs the configuration code to the development server. The version management module converts the configuration code into configuration data corresponding to a data structure of the development database and inputs the configuration data into the development database. The development database stores the configuration data in a corresponding storage block according to an application type and a version category of the configuration data.

### CROSS-REFERENCE TO RELATED APPLICATION

This application claims the priority benefit of China application serial no. 202310615518.5, filed on May 29, 2023. The entirety of the above-mentioned patent application is hereby incorporated by reference herein and made a part of this specification.

### BACKGROUND

### Technical Field

The disclosure relates to an application program management technology, in particular to an application program management system and an application program management method directed to different types of application programs and different versions of application branch data.

### Description of Related Art

A common problem today in application program management among multiple developers or multiple clients is application program and version management. Due to the inconsistency of the version update rhythm of the application program corresponding to the local environment of different users, the storage and management of the application program have multiple versions and multiple application programs coexisting, and even because there is no unified management system, it is not easy to manage application programs with different version update frequencies and are prone to version errors and conflicts. From another point of view, the inconsistency of the original data structure of the application makes it difficult for the version management system to compare the differences between each version, and at the same time, it is difficult to add, delete, modify, or query the application program. Moreover, traditional databases record data changes based on a log, which makes it difficult to manage the version of a specific application program according to the needs of individual users.

### SUMMARY

The disclosure relates to an application program management system and an application program management method, which can realize operations of tracing, rollback, and merging of different application versions, and the management function of using different storage blocks for different application codes and different versions respectively.

According to an embodiment of the disclosure, the application program management system of the disclosure includes a development server, a version manager, and a development database. The development server includes and executes a version management module. When the version management module receives a branch establishing command, a corresponding branch is established according to the branch establishing command and inputs version application information in the branch establishing command into the version manager. The version manager searches and obtains a corresponding configuration code according to the version application information and inputs the configuration code into the development server. The version management module converts the configuration code into configuration data corresponding to a data structure of the development database and inputs the configuration data into the development database. In this way, the development database stores the configuration data in a corresponding storage block according to an application type and a version category of the configuration data.

According to an embodiment of the disclosure, the application program management method of the disclosure is suitable for an application program management system. The application program management system includes a development server. The development server includes and executes a version management module. When receiving a branch establishing command, the version management module establishes a corresponding branch according to the branch establishing command and inputs version application information into a version manager. The version manager obtains a corresponding configuration code according to the version application information and inputs the configuration code into the development server.

The version management module converts the configuration code into configuration data corresponding to a development database and inputs the configuration data into the development database. The development database stores the configuration data in a corresponding storage block according to an application type and a version category of the configuration data.

Based on the above, the application program management system and the application program management method of the disclosure can effectively manage multiple application codes and multiple version data of each application code.

In order to make the above-mentioned features and advantages of the disclosure more comprehensible, the following embodiments are described in detail together with the accompanying drawings.

### BRIEF DESCRIPTION OF THE DRAWINGS

FIG. 1 is a schematic diagram of an application program management system according to an embodiment of the disclosure.

FIG. 2 is a flow chart of establishing a branch of an application program management method according to an embodiment of the disclosure.

FIG. 3 is a schematic diagram of an architecture of a development server according to an embodiment of the disclosure.

FIG. 4 is a schematic diagram of a branch establishment process according to an embodiment of the disclosure.

FIG. 5 is a flow chart of submitting a change record of an application program according to an embodiment of the disclosure.

FIG. 6 is a flow chart of data synchronization according to an embodiment of the disclosure.

FIG. 7 is a flow chart of merging different branches in the application program according to an embodiment of the disclosure.

FIG. 8 is a schematic diagram of an architecture of a deployment server according to an embodiment of the disclosure.

FIG. 9 is a schematic diagram of a compilation process and a version release process of the application program according to an embodiment of the disclosure.

### DESCRIPTION OF THE EMBODIMENTS

Reference will now be made in detail to the exemplary embodiments of the disclosure, examples of which are illustrated in the accompanying drawings. Wherever possible, the same reference numerals are used in the drawings and descriptions to refer to the same or like parts.

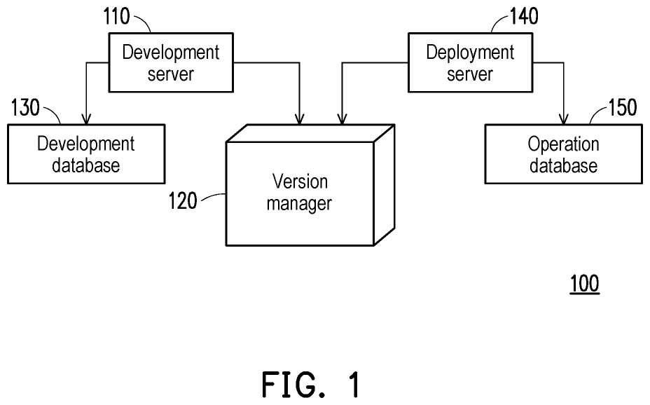

FIG. 1 is a schematic diagram of an application program management system according to an embodiment of the disclosure. Referring to FIG. 1, an application program management system 100 includes a development server 110, a version manager 120, and a development database 130. The version manager 120 is coupled (e.g., communicatively connected) to the development server 110. The development database 130 is coupled to the development server 110. In an embodiment, the development server 110 may be a cloud server, and may include and/or execute one or more application services corresponding to one or more cloud application programming interfaces (APIs). In an embodiment, the version manager 120 is a version management server for various application programs. In an embodiment, the version manager 120 is a GIT file software version control system. In an embodiment, the version manager 120 is an Apache Subversion (svn) software version control system, but the disclosure is not limited thereto.

In this embodiment, the application program management system 100 includes one or more servers and is not limited to as shown in FIG. 1. In an embodiment, the development server 110, the version manager 120, and the development database 130 are disposed in the same server, and a deployment server 140 and an operation database 150 are respectively disposed in different servers. In another embodiment, the development server 110, the version manager 120, the development database 130, and the deployment server 140 are respectively disposed and executed on different servers, and the disclosure should not be limited thereto. In this embodiment, the server (such as the development server 110 or the deployment server 140) may respectively include a processor and a storage device. The processor may include, for example, a central processing unit (CPU), or other programmable general-purpose or special-purpose microprocessors, a digital signal processor (DSP), an application specific integrated circuit, ASIC), a programmable logic device (PLD), other similar processing circuits, or a combination of these devices. The storage device may include a memory and/or a database, in which the memory may be, for example, a non-volatile memory (NVM). A storage module may store related programs, modules, systems, or algorithms configured to implement various embodiments of the disclosure, for the processor to access and execute to realize relevant functions and operations described in the various embodiments of the disclosure. In this embodiment, a version management module, a data synchronization module, a merge management module, a user management module, a data management module, a compilation management module, and a version release management module may be, for example, realized by program languages such as JSON (JavaScript Object Notation), extensible markup language (XML) or YAML or the like, but the disclosure is not limited thereto.

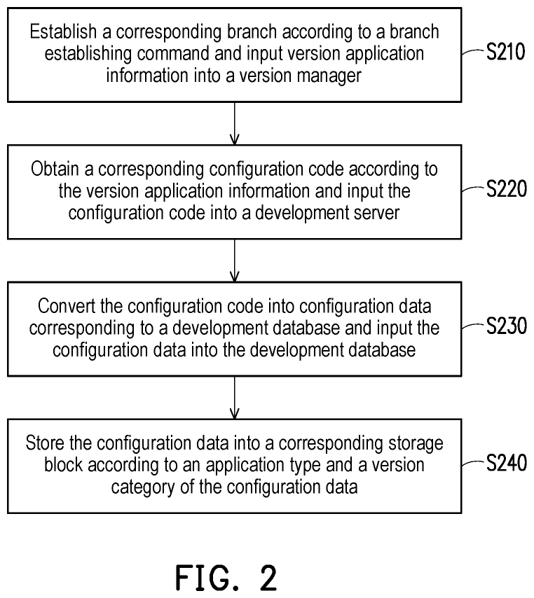

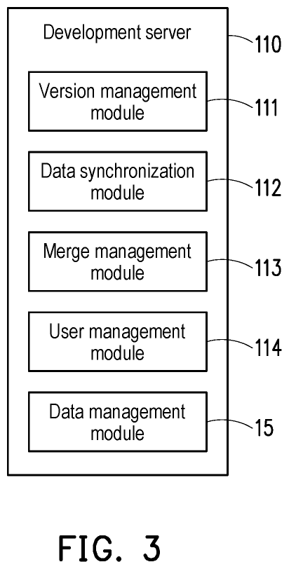

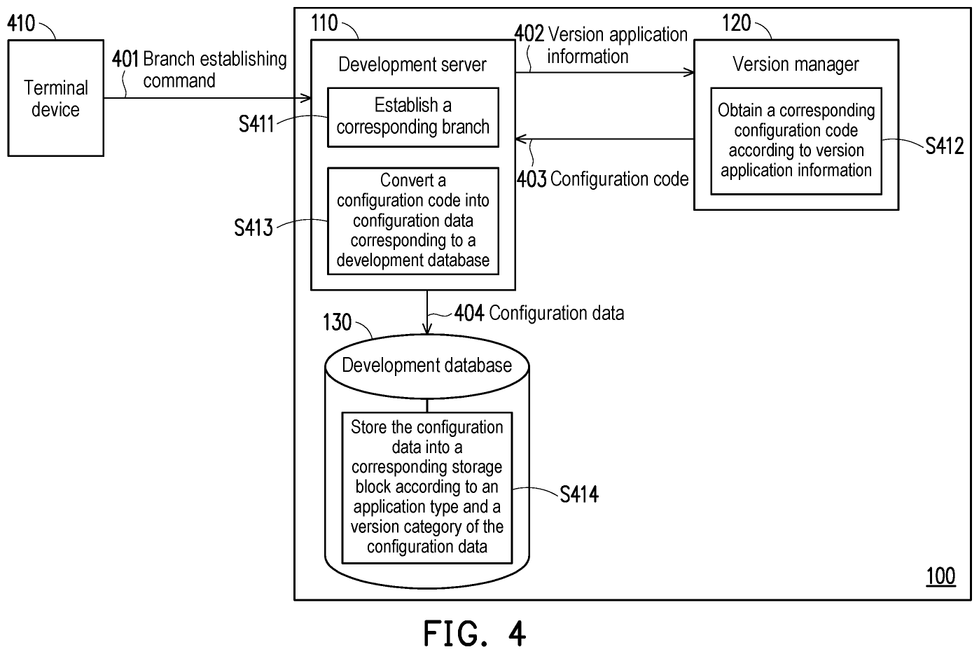

FIG. 2 is a flow chart of establishing a branch of an application program management method according to an embodiment of the disclosure. FIG. 3 is a schematic diagram of an architecture of a development server according to an embodiment of the disclosure. FIG. 4 is a schematic diagram of a branch establishment process according to an embodiment of the disclosure. Referring to FIG. 1, FIG. 2, FIG. 3, and FIG. 4, the development server 110 includes a version management module 111, a data synchronization module 112, and a merge management module 113. In this embodiment, the application program management system 100 may execute branch establishment as of the following Steps S210 to S240. In Step S210, the version management module 111 establishes a corresponding branch according to a branch establishing command 401 and inputs version application information 402 in the branch establishing command 401 into the version manager 120. For example, a user communicates with the development server 110 by operating a terminal device 410 and then send the branch establishing command 401 to the development server 110. The version management module 111 in the development server 110 establishes a new branch according to the version application information 402 in the branch establishing command 401 (that is, Step S411). In addition, the version management module 111 outputs the version application information 402 in the branch establishing command 401 to the version manager 120. In an embodiment, the terminal device 410 is such as a personal desktop computer, a smart phone, or a tablet of the user.

In Step S220, the version manager 120 obtains a corresponding configuration code 403 according to the version application information 402 (that is, Step S412). Next, the version manager 120 inputs the configuration code 403 into the development server 110. Specifically, the version manager 120 searches the version manager 120 for the corresponding configuration code 403 according to an application type and a version category of the version application information 402 and then obtains the corresponding configuration code 403. For example, the version application information 402 includes an application type to be established currently (such as a first application program, a second application program, an application program related to services, or an application program related to configuration settings) and a version category to be established currently (such as a first version, a second version, or a third version). In this way, the version manager 120 searches a storage space in the version manager 120 for the corresponding configuration code 403 (such as a code of the application program or a code related to the configuration of the application program) according to the application type and the version category included in the version application information 402.

In Step S230, the version management module 111 converts the configuration code 403 into configuration data 404 corresponding to the development database 130 (Step S413) and then inputs the configuration data 404 into the development database 130. Specifically, after receiving the configuration code 403, the version management module 111 converts the configuration code 403 into the corresponding configuration data 404 according to a data structure and a database category (such as a mongo database, a graph database, a neo4j database category) of the development database 130. In this way, the version management module 111 converts the data into a data format conforming to the database, so as to achieve the uniformity of the data structure and make it easier for the version manager 120 to compare the differences between multiple versions in the same application category.

In Step S240, the development database 130 stores the configuration data 404 in a corresponding storage block according to an application type and a version category corresponding to the configuration data 404 (Step S414). In this way, when a new branch needs to be established due to different application programs, different users, or different versions, the development server 110 establishes a new branch (that is, the version) in the version manager 120 and the configuration data 404 of the new branch is written into the development database 130. It is worth noting that the development server 110 also copies data content in the development database 130 related to before establishing the new branch, so as to complete the backup, establishment, storage, and management of each version (that is, the branch) of the application program. In other words, the application program management system 100 can provide users with a unified management portal for multiple application programs and respective versions through the development server 110, thereby improving the convenience for users in managing application programs.

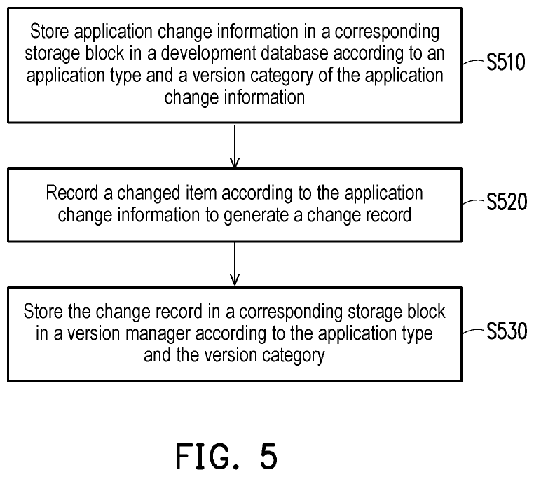

FIG. 5 is a flow chart of submitting a change record of an application program according to an embodiment of the disclosure. Referring to FIG. 1, FIG. 3, and FIG. 5, the application program management system 100 may execute a flow of changing a record as of the following Steps S510 to S530. In Step S510, the version management module 111 stores application change information in a corresponding storage block in the development database 130 according to an application type and a version category in the application change information. Specifically, the user inputs configuration change information (that is, the application change information, and including version information) into the version management module 111 through the terminal device 410. It is worth noting that, in an embodiment, after receiving the application change information, the version management module 111 first performs a structure unifying process to the application change information (for example, converting into a data structure conforming to the current storage space).

In Step S520, the version manager 120 records a changed item according to the application change information to generate a change record, and the change record includes at least one of a submission record of the application type, the version category, and a code change. Specifically, after performing unifying the data structure to the application change information, the version management module 111 obtains a pre-change application code corresponding to the application change information from the development database 130 and then the pre-change application code and a current application code (that is, the application program corresponding to the change information and currently changed content) are input into the development database 130 and the version manager 120.

In Step S530, the version manager 120 stores the change record in a corresponding storage block in the version manager 120 according to the application type and the version category. In other words, the version manager 120 stores the change record in the corresponding storage block in the version manager 120 according to the application program and the corresponding version corresponding to the change record (that is, the version category). That is to say, the version manager 120 of the application program management system 100 performs storage by using different storage blocks (such as an application warehouse) according to different applications and store in different detailed storage blocks according to different versions in the application program, so that a branch of each period and each type of the application program is stored.

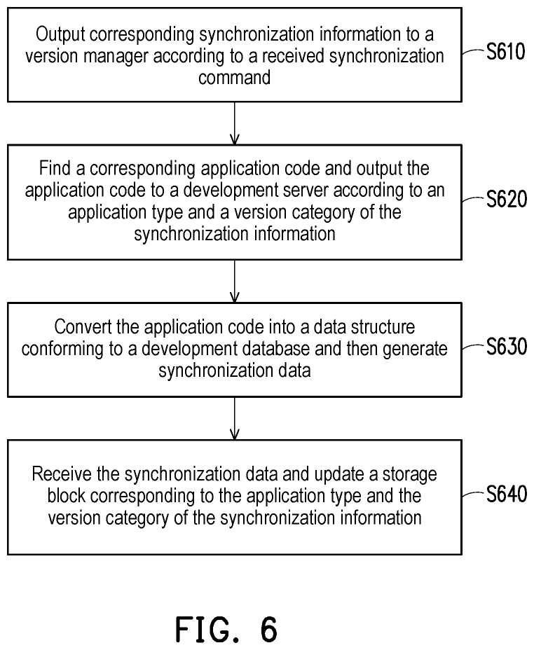

FIG. 6 is a flow chart of data synchronization according to an embodiment of the disclosure Referring to FIG. 1, FIG. 3, and FIG. 6, the application program management system 100 can execute a flow of data synchronization as of the following Steps S610 to S640. In Step S610, the data synchronization module 112 outputs corresponding synchronization information to the version manager 120 according to a synchronization command, which is received. Specifically, the synchronization command includes the application type and the version category to be synchronized. In this way, the data synchronization module 112 uses the application type and the version category in the synchronization command as synchronization information and inputs the synchronization information to the version manager 120.

Next, in Step S620, the version manager 120 finds a corresponding application code according to an application type and a version category of the synchronization information. In an embodiment, the version manager 120 searches out the corresponding application code (that is, the code of the application program) from the storage block in the version manager 120 according to the synchronization information (including the application type and the version category). Also, the version manager 120 outputs the application code to the development server 110. In Step S630, the data synchronization module 112 converts the application code into a data structure conforming to the development database 130 and then generates synchronization data. In Step S640, the development database 130 receives the synchronization data (that is, the application program code conforming to the data structure of the development database 130) and updates data (that is, the application code) in a storage block corresponding to the application type and the version category of the synchronization information. In this way, the user may send a synchronization command to the development server 110 through the terminal device 410, so that the application program management system can automatically complete the data synchronization process between the development database 130 and the version manager 120, thereby ensuring the consistency of the application types and version contents between the storage spaces.

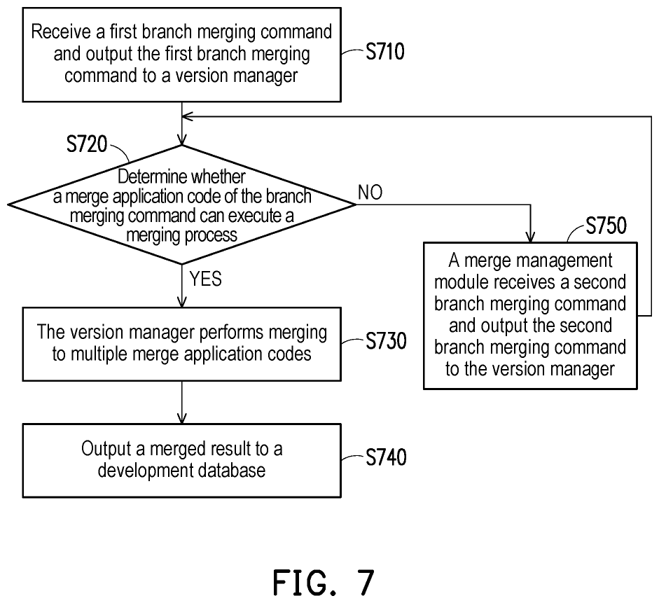

FIG. 7 is a flow chart of merging different branches in the application program according to an embodiment of the disclosure. Referring to FIG. 1, FIG. 3, and FIG. 7, the application program management system 100 may execute a flow of data synchronization as of the following Steps S710 to S750. In Step S710, the merge management module 113 receives a first branch merging command and outputs the first branch merging command to the version manager 120. In an embodiment, the user outputs a branch merging command (such as the first branch merging command, a second branch merging command) by operating the terminal device 410 communicatively connected with the development server 110. Moreover, after receiving the branch merging command, the merge management module 113 transmits the branch merging command to the version manager 120.

In Step S720, the version manager 120 determines whether multiple merge application codes corresponding to the branch merging command can execute a merging process. Specifically, when the version manager 120 determines that different branches (that is, different versions) of the application program code corresponding to the branch merging command have conflicts with each other, then it is determined that the application program version may not be directly merged. On the contrary, when the version manager 120 determines that the different branches of the application program code do not have conflicts with each other, then it is determined that the application program version may be directly merged. For example, the merging branch command is a command for merging a branch (i.e. version) A1 and a branch A2 of an application program A, and the version manager 120 determines whether codes or settings in the branch A1 and the branch A2 have conflicts by using the API of the application program A. When a configuration file A5 (such as a configuration setting or a layout setting) in the branch A1 of the application program A is modified to a first version, the configuration file A5 in the branch A2 of the application program A is modified to a second version, and if the first version and the second version cannot coexist and cause conflicts, then the version manager 120 determines that the branch merging command of the application program A cannot be directly merged.

In Step S730, when the version manager 120 determines that the multiple merge application codes corresponding to the branch merging command belong to codes that can execute the merging process, the version manager 120 performs merging to the multiple merge application codes. Also, the version manager 120 outputs a merged result to the development database 130 (Step S740).

When a determined result of Step S720 is that direct merging is not possible, that is to say, when the version manager 120 determines that the multiple merge application codes corresponding to the branch merging command belong to codes that cannot execute the merging process, the version manager 120 outputs a determined result and executes Step S750. It is worth noting that when the version manager 120 outputs the determined result of the merging being inexecutable to the development server 110, the determined result output by the version manager 120 includes conflicting branch content, the code of the application program, suggested options, and suggested contents, so that the user may select or input the branch and the option to be selected in the conflicted branches. For example, when the branch A1 and the branch A2 in the application program A have conflicts, suggested options include using the branch A1 as primary, or using the branch A2 as primary, then the user may choose to use the branch A1 as primary, and then make the version manager 120 use the setting (that is, the code content) of the branch A1 as primary when conflicts arise while merging branches.

In Step S750, the merge management module 113 receives the second branch merging command and outputs the second branch merging command to the version manager 120, so as to repeatedly execute Step S720. In other words, the version manager 120 determines whether the second branch merging command belongs to a code that can execute the merging process, and repeatedly execute Step S730 or Step S750 according to the determined result. For example, the user receives the determined result that the branch merging command issued by the version manager 120 in Step S720 is not possible to be merged directly, then the user modifies the branch merging command or the user solves the conflicting part in the application program (for example, selects the configuration file to be kept, or selects the settings to be kept in the conflicting settings) and inputs the second branch merging command to the merge management module 113. In this way, the version manager 120 performs a determining process on the second branch merging command again to confirm whether the second branch merging command can be merged.

In an embodiment, the version manager 120 and the merge management module 113 repeatedly execute Step S710 to S750 according to the branch merging command (for example, the first branch merging command, the second branch merging command, or the subsequently received branch merging command), until no more new branch merging command is received or a stop merging command transmitted by the user is received.

In an embodiment, the development server 110 further includes a user management module 114 and a data management module 115. The user management module 114 is configured to determine whether the current application code conforms to a permission setting according to the permission setting corresponding to the command. Specifically, when the user management module 114 receives various commands (such as branch merging commands, modification commands, branch establishing commands), the user management module 114 determines whether the current user has the permission to perform setting and modifying according to the application program corresponding to the command and a permission setting table. In other words, the user management module 114 may control an access right of a relevant user to the configuration code 403 of different applications programs, and only users with relevant rights can view and modify the codes in the application programs, thereby improving the stability and management efficiency of the application program codes.

In an embodiment, the data management module 115 is configured to generate an application path (that is, an application program route) according to the branch establishing command 401. The application path may be a configuration route related to the application programs. Furthermore, the data management module 115 inputs the application path into the development database 130. In this way, the development database 130 may store the configuration data 404 (that is, the corresponding application program code) in the corresponding storage block according to the application path.

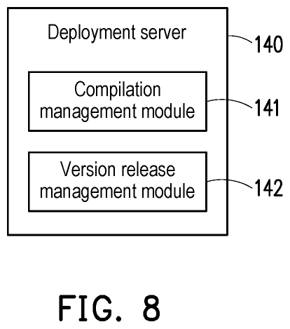

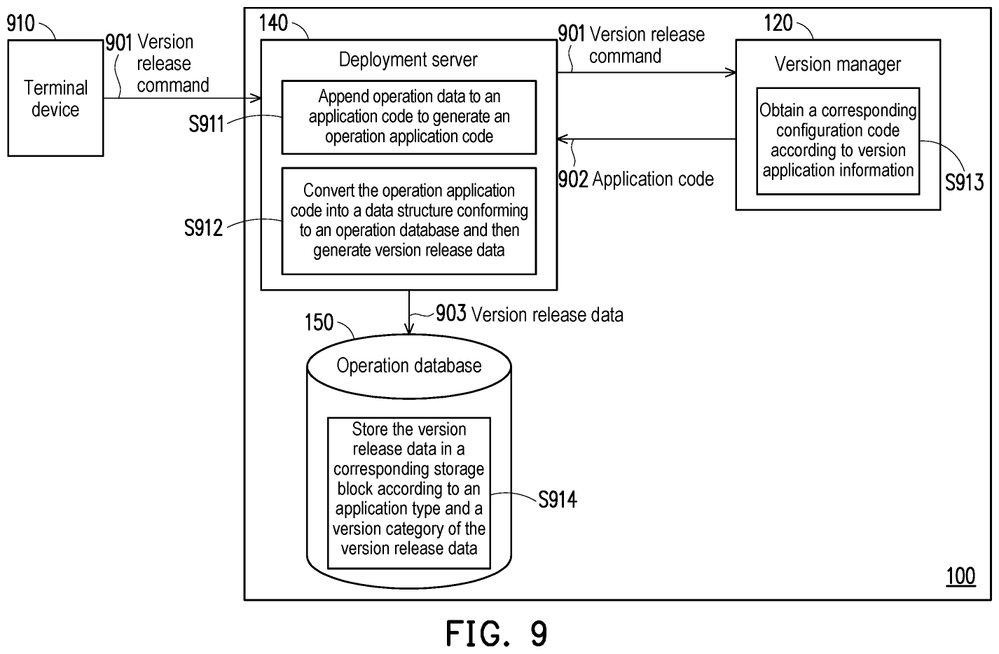

FIG. 8 is a schematic diagram of an architecture of a deployment server according to an embodiment of the disclosure. FIG. 9 is a schematic diagram of a compilation process and a version release process of the application program according to an embodiment of the disclosure. The application program management system 100 includes the deployment server 140 and the operation database 150. The deployment server 140 is coupled to the version manager 120. The operation database 150 is coupled to the deployment server 140. The deployment server 140 includes a compilation management module 141 and a version release management module 142. Referring to FIG. 1, FIG. 8, and FIG. 9, the application program management system 100 can execute a flow of data synchronization as of the following Steps S911 to S914. The user outputs a version release command 901 to the deployment server 140 of the application program management system 100 by operating a terminal device 910. Next, the deployment server 140 inputs the version release command 901 into the version manager 120 and then obtains the corresponding configuration code according to the version application information corresponding to the version release command 901 (Step S913). In this way, the deployment server 140 receives an application code 902 (i.e., the configuration code corresponding to the application information) from the version manager 120.

In Step S911, the deployment server 140 appends operation data to the application code 902 to generate an operation application code, so that when the application program is upgraded or updated, the user experience is less affected and the smoothness overall is increased during a version update. Specifically, the deployment server 140 appends data or modified codes generated when the terminal actually runs the application program to the application code 902, that is, adds the data changes generated according to actual use to the application code 902. In Step S912, the deployment server 140 converts the operation application code into a data structure conforming to the operation database 150 and then generates version release data 903. Next, the deployment server 140 inputs the version release data 903 into the operation database 150. In Step S914, the operation database 150 stores the version release data 903 in a corresponding storage block according to the application type (i.e., the type of the application program) and the version category (i.e., the branch) of the version release data 903.

In summary, the application program management system 100 and the application program management method of the disclosure can realize operations of tracing, rollback, and merging of different application versions, and the management function of using different storage blocks for different application codes 902 and different versions respectively. Also, according to the communication connection of the version manager 120 to the database (such as the development database 130 or the operation database 150), the version manager 120 can add, delete, modify, or view the application program code in the database, so that the management efficiency and the convenience of use of the application program are improved.

Finally, it should be noted that the above embodiments are only used to illustrate the technical solutions of the disclosure, rather than to limit the disclosure. Although the disclosure has been described in detail with reference to the embodiments, persons skilled in the art should understand that: the technical solutions described in the foregoing embodiments may still be modified, or equivalent replacements for some or all of the technical features may be performed. However, the modifications or replacements do not make the essence of the corresponding technical solutions depart from the scope of the technical solutions of the embodiments of the disclosure.

What is claimed is:

1. An application program management system, comprising:
a development server comprising a version management module;
a version manager coupled to the development server;
a development database coupled to the development server;
wherein the version management module establishes a corresponding branch according to a branch establishing command and inputs version application information into the version manager;
wherein the version manager obtains a corresponding configuration code according to the version application information and inputs the configuration code into the development server;
wherein the version management module converts the configuration code into configuration data corresponding to the development database and inputs the configuration data into the development database;
wherein the development database stores the configuration data in a corresponding storage block according to an application type and a version category of the configuration data.

2. The application program management system according to claim 1, wherein the version management module receives application change information,
wherein the version management module stores the application change information in a corresponding storage block in the development database according to an application type and a version category in the application change information,
wherein the version manager records a changed item according to the application change information to generate a change record and stores the change record in a corresponding storage block in the version manager according to the application type and the version category.

3. The application program management system according to claim 2, wherein the change record comprises at least one of a submission record of the application type, the version category, and a code change.

4. The application program management system according to claim 1, wherein the development server further comprises a data synchronization module,
wherein the data synchronization module is configured to output corresponding synchronization information to the version manager according to a synchronization command, which is received,
wherein the version manager finds a corresponding application code according to an application type and a version category of the synchronization information and outputs the application code to the development server,
wherein the data synchronization module converts the application code into a data structure conforming to the development database and then generates synchronization data,
wherein the development database receives the synchronization data and updates a storage block corresponding to the application type and the version category of the synchronization information.

5. The application program management system according to claim 1, wherein the development server further comprises a merge management module,
wherein the merge management module receives a first branch merging command and outputs the first branch merging command to the version manager,
wherein the version manager determines whether a plurality of merge application codes corresponding to the first branch merging command can execute a merging process,
when the version manager determines that the plurality of merge application codes belong to codes that can execute the merging process, the version manager performs merging to the plurality of merge application codes and outputs a merged result to the development database.

6. The application program management system according to claim 5, wherein when the version manager determines that the plurality of merge application codes belong to codes that cannot execute the merging process, the version manager outputs a determined result,
wherein the merge management module receives a second branch merging command and outputs the second branch merging command to the version manager,
wherein the version manager determines whether the second branch merging command belongs to a code that can execute the merging process.

7. The application program management system according to claim 1, wherein the development server further comprises a user management module and a data management module,
wherein the user management module is configured to determine whether a current application code conforms to a permission setting according to the permission setting corresponding to the command,
wherein the data management module is configured to generate an application path according to the branch establishing command and input the application path into the development database,
wherein the development database stores the configuration data in the corresponding storage block according to the application path.

8. The application program management system according to claim 1, further comprising a deployment server, wherein the deployment server is coupled to the version manager and comprises a compilation management module,
wherein the compilation management module receives a version release command and obtains a corresponding application code from the version manager according to the version release command,
wherein the compilation management module appends operation data to the application code to generate an operation application code.

9. The application program management system according to claim 8, further comprising an operation database, wherein the operation database is coupled to the deployment server,
wherein the deployment server further comprises a version release management module,
wherein the version release management module converts the operation application code into a data structure conforming to the operation database and then generates version release data,
wherein the version release management module inputs the version release data into the operation database.

10. An application program management method suitable for an application program management system, wherein the application program management system comprises a development server, wherein the development server comprises and executes a version management module, wherein the application program management method comprises:
when the version management module receives a branch establishing command, the version management module establishing a corresponding branch according to the branch establishing command and inputting version application information into a version manager;
the version manager obtaining a corresponding configuration code according to the version application information and inputting the configuration code into the development server;
the version management module converting the configuration code into configuration data corresponding to a development database and inputting the configuration data into the development database; and
the development database storing the configuration data in a corresponding storage block according to an application type and a version category of the configuration data.

11. The application program management method according to claim 10, further comprising:
when the version management module receives application change information, the version management module storing the application change information in a corresponding storage block in the development database according to an application type and a version category in the application change information; and
the version manager recording a changed item according to the application change information to generate a change record and storing the change record in a corresponding storage block in the version manager according to the application type and the version category.

12. The application program management method according to claim 11, wherein the change record comprises at least one of a submission record of the application type, the version category, and a code change.

13. The application program management method according to claim 10, wherein the development server further comprises a data synchronization module, wherein the method further comprises:
the data synchronization module receiving a synchronization command and then outputting corresponding synchronization information to the version manager;
the version manager finding a corresponding application code according to an application type and a version category of the synchronization information;
the version manager outputting the application code to the development server;
the data synchronization module converting the application code into a data structure conforming to the development database and then generating synchronization data;
the development database receiving the synchronization data; and
the development database updating a storage block corresponding to the application type and the version category of the synchronization information.

14. The application program management method according to claim 10, wherein the development server further comprises a merge management module, wherein the application program management method further comprises:
the merge management module receiving a first branch merging command;
the merge management module outputting the first branch merging command to the version manager;
the version manager determining whether a plurality of merge application codes corresponding to the first branch merging command can execute a merging process;
when the version manager determines that the plurality of merge application codes belong to codes that can execute the merging process, the version manager performing merging to the plurality of merge application codes and outputting a merged result to the development database.

15. The application program management method according to claim 14, wherein when the version manager determines that the plurality of merge application codes belong to codes that cannot execute the merging process, the version manager outputs a determined result;
the merge management module receives a second branch merging command and outputs the second branch merging command to the version manager; and
the version manager determines whether the second branch merging command belongs to a code that can execute the merging process.

16. The application program management method according to claim 10, wherein the development server further comprises a user management module and a data management module, wherein the application program management method comprises the following:
the user management module determining whether a current application code conforms to a permission setting according to the permission setting corresponding to the command,
the data management module generating an application path according to the branch establishing command and inputting the application path into the development database; and
the development database storing the configuration data in the corresponding storage block according to the application path.

17. The application program management method according to claim 10, wherein the application program management system further comprises a deployment server, wherein the deployment server comprises a compilation management module, wherein the application program management method further comprises:
the compilation management module receiving a version release command;
the compilation management module obtaining a corresponding application code from the version manager according to the version release command; and
the compilation management module appending operation data to the application code to generate an operation application code.

18. The application program management method according to claim 17, wherein the deployment server further comprises a version release management module, wherein the application program management method further comprises:
the version release management module converting the operation application code into a data structure conforming to an operation database and then generating version release data;
the version release management module inputting the version release data into the operation database.
